(19) United States
(12) Patent Application Publication
(10) Pub. No.: US 2013/0124427 A1
(43) Pub. Date: May 16, 2013

(54) METHOD AND SYSTEM FOR ADMINISTERING A LEGAL PROCEEDING USING A POSTCARD MAILER WITH A QR CODE

(71) Applicant: Kurtzman Carson Consultants, LLC, Novato, CA (US)

(72) Inventors: James M. Le, Huntington Beach, CA (US); Patrick M. Passarella, Powell, OH (US); Kathryn E. Horton, Rohnert Park, CA (US)

(73) Assignee: KURTZMAN CARSON CONSULTANTS, LLC, Novato, CA (US)

(21) Appl. No.: 13/674,499

(22) Filed: Nov. 12, 2012

Related U.S. Application Data
(60) Provisional application No. 61/558,143, filed on Nov. 10, 2011.

(51) Int. Cl. G06Q 50/18

(52) U.S. Cl. 705/311

(57) ABSTRACT

According to some embodiments of the present disclosure, systems and methods for administering a legal proceeding are disclosed. The method includes receiving recipient data including a recipient name, a recipient address, and a unique recipient identifier. The recipient is one of a plurality of recipients associated with the proceeding. The unique recipient identifier distinguishes the recipient from the other recipients of the plurality of recipients. The method further includes receiving sender data including a sender name and a sender address. The method further includes receiving a network location identifier identifying a network address of a website that the recipient is to access and perform a requested action and generating a QR code based on the network location and the unique recipient identifier. The method further includes generating a layout of postcard based on the QR code, the recipient data, and the sender data, printing the postcard, and mailing the postcard.

### CROSS-REFERENCE TO RELATED APPLICATIONS

This application claims the benefit of U.S. Provisional Application No. 61/558,143, filed on Nov. 10, 2011, the entire disclosure of which is incorporated herein by reference.

### FIELD

The present disclosure relates to a method and system for administering a legal proceeding using a postcard having a Quick Response (QR) code.

### BACKGROUND

This section provides background information related to the present disclosure which is not necessarily prior art.

As can be appreciated many types of legal proceedings involving one or more parties in interest may require claims administration or other administrative services. For example, in a class action proceeding, members of a class may be required to file claims, and may need to affirm or modify information regarding the member with respect to the proceeding. Similarly, in a bankruptcy proceeding, claimants may need to be provided with information and may also be required to vote on issues or to file claims. Today, forms are sent to the parties in envelopes, which recipients must review to identify forms to be returned to the administrator of the proceeding. These forms may require full first class postage to be sent to the party, and full first class postage to be returned to the administrator.

### SUMMARY

This section provides a general summary of the disclosure, and is not a comprehensive disclosure of its full scope or all of its features.

According to some embodiments of the present disclosure, a method for administering a legal proceeding is disclosed. The method includes receiving recipient data including a recipient name and a recipient address, wherein the recipient is one of a plurality of recipients associated with the legal proceeding. The method further includes receiving sender data including a sender name and a sender address and receiving a network location identifying a network address of a website that the recipient is to access and to perform a requested action. The method further includes generating a QR code based on the network location and generating a layout for a postcard based on the QR code, the recipient data, and the sender data. The method further includes printing the postcard and mailing the postcard.

According to some embodiments of the present disclosure, a method for administering a legal proceeding is disclosed. The method includes receiving recipient data including a recipient name, a recipient address, and a unique recipient identifier. The recipient is one of a plurality of recipients associated with a legal proceeding. The unique recipient identifier distinguishes the recipient from the other recipients of the plurality of recipients. The method further includes receiving sender data including a sender name and a sender address. The method further includes receiving a network location identifier identifying a network address of a website that the recipient is to access and perform a requested action and generating a QR code based on the network location and the unique recipient identifier. The method further includes generating a layout of postcard based on the QR code, the recipient data, and the sender data, printing the postcard, and mailing the postcard.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a drawing illustrating an exemplary system for administering a legal proceeding according to some embodiments of the present disclosure;

FIG. 2A is a drawing illustrating a front side of a postcard having a QR code embedded thereon according to some embodiments of the present disclosure;

FIG. 2B is a drawing illustrating a back side of a postcard having a QR code embedded thereon according to some embodiments of the present disclosure; and

FIG. 3 is a flow chart illustrating an exemplary method for administering a legal proceeding according to some embodiments of the present disclosure.

Corresponding reference numerals indicate corresponding parts throughout the several views of the drawings.

### DETAILED DESCRIPTION

Example embodiments will now be described more fully with reference to the accompanying drawings.

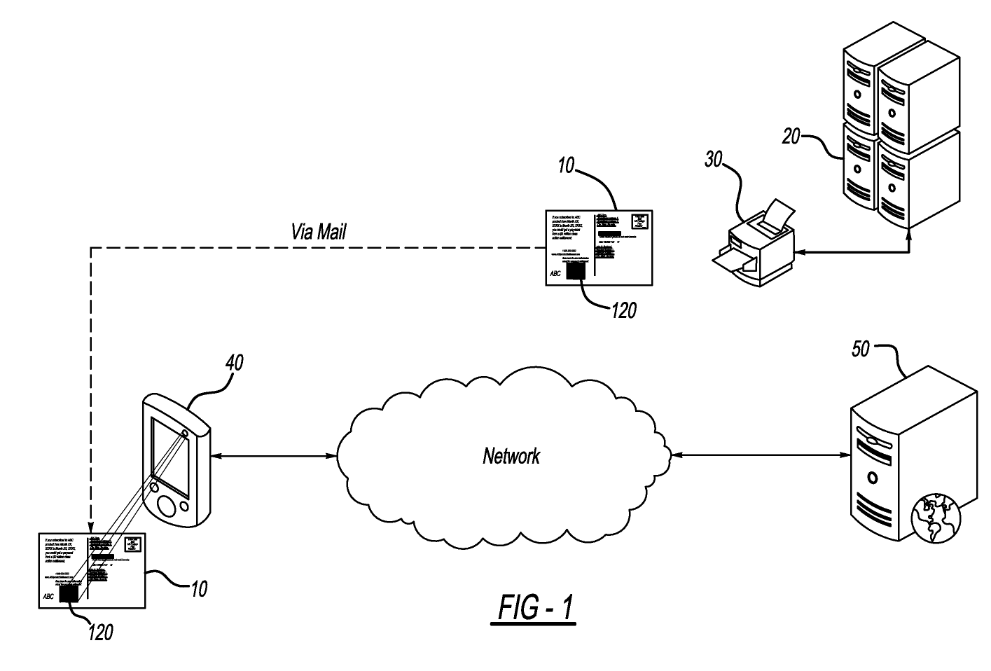

Referring now to FIG. 1, a system for administering a legal proceeding using a postcard 10 having a quick response (QR) code 120 printed thereon is illustrated. As used herein, the term “postcard” can refer to any printed matter that is sent to a recipient via a postal service, i.e., in the “mail.” Further, the term “legal proceeding” can refer to any civil action having two or more similarly situated parties. Examples of legal proceedings can include, but are not limited to, class action lawsuits and bankruptcy proceedings. In the context of class action lawsuits, the recipient could be a class member or a potential class member. In the bankruptcy proceeding context, the recipient could be a claimant or potential claimant.

In some embodiments, the system includes a postcard generation apparatus 20, which generates the layout of the postcard 10 including the QR code 120, and a printing apparatus 30 that prints the postcard 10. As shown in FIG. 1, the postcard generation apparatus 20 is a server having one or more processors. It should be appreciated, however, that the postcard generation apparatus 20 can be any computing device, including a desktop computing device.

The postcard generation server 20 can receive input such as a list of recipients and recipient data for each of the recipients. The recipient data of a recipient can include a name of the recipient, an address of the recipient, and, in some embodiments, a unique recipient identifier for each of the recipients. The unique recipient identifier distinguishes a recipient from other recipients in the list. As should be appreciated, the unique recipient identifier can be a numeric, alphanumeric, or character string. The postcard generation apparatus 20 can also receive sender information, including a name of the sender and an address of the sender. It should be appreciated that the sender can be an entity or a person. The postcard generation apparatus also receives a network location of a webserver 50 that the recipient is to access. For example, the network location can be a uniform resource locator (URL), or any other suitable convention for referencing the webserver 50.

Prior to printing the postcard 10, the postcard generation apparatus 20 generates a layout of the postcard 10 based on the recipient data, the sender information, and the network location. The postcard generation apparatus 20 generates a QR code 120 based on the network location, such that the network location is encoded in the QR code 120. The QR code 120 can be generated using any suitable technique. Furthermore, in some embodiments the postcard generation apparatus 20 is configured to generate the QR code 120 based on the network location and the unique recipient identifier. In these embodiments, the network location and the unique record identifier are encoded into the QR code 120.

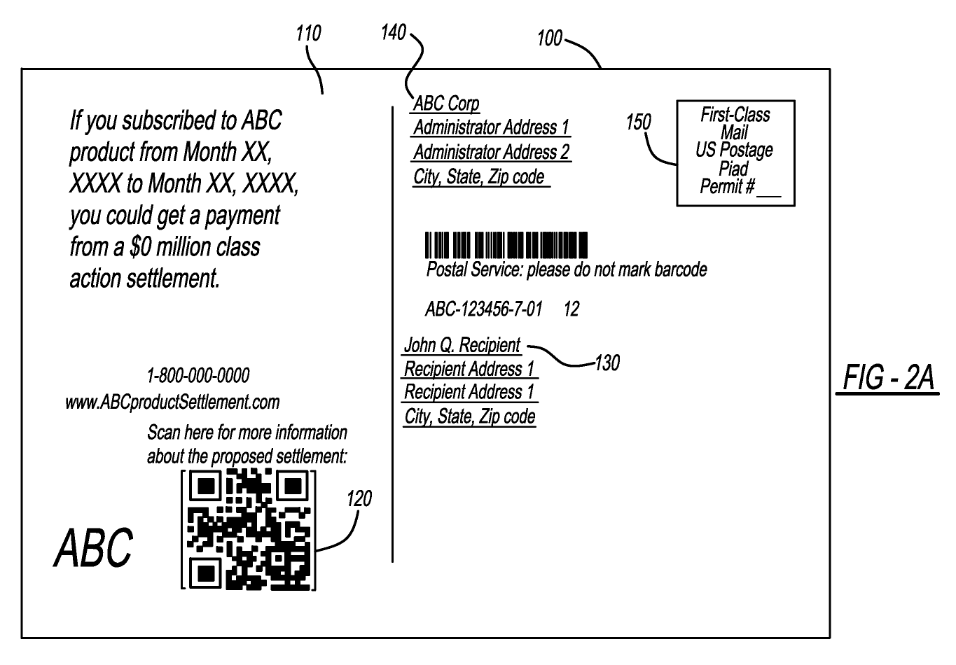

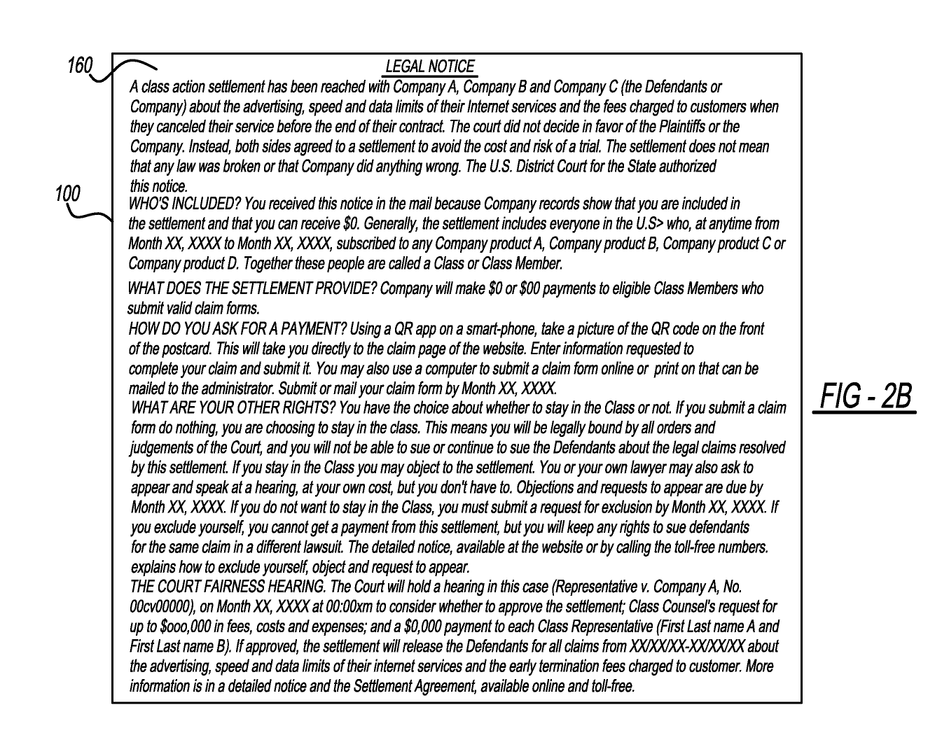

Once the QR code is generated, the postcard generation apparatus generates the layout of the postcard 10. Referring now to FIGS. 2A and 2B, an example postcard 10 is illustrated. FIG. 2A illustrates an example of the front 110 of a postcard 10 according to some embodiments of the present disclosure. The front 110 of the postcard 10 includes the QR code 120, a recipient name and address 130, and a sender name and address 140, and postage 150. As can be appreciated, the recipient name and address 130 designates to whom and where the postcard 10 is to be delivered. The sender name and address 140 designates from whom and where the postcard 10 is sent. The postage 150 is placed on the postcard 10 so that a mail carrier will deliver the postcard 10.

Referring now to FIG. 2B, the back 160 of the postcard 10 is illustrated. The back 160 of the postcard 10 can be utilized to provide information to the recipient. For example, notice information, instructions and/or frequently asked questions can be printed on the back of the postcard 10. The language provided in the example of FIG. 2B is provided for context only. It should be appreciated that any information may be included on the back 160 of the postcard 10, and the example is not intended to be limiting. It is appreciated that the back 160 of the postcard 10 can be utilized for other purposes as well. Furthermore, in some embodiments, the QR code 120 may be included on the back 160 of the postcard.

Referring back to FIG. 1, the postcard 10 is sent to a recipient via a postal service, e.g., the “mail.” The recipient can scan the postcard 10 using a computing device 40, such that the computing device 40 decodes the QR code 120 to obtain a network location, e.g., a URL, and, in some embodiments, the unique recipient identifier. As shown in FIG. 1, the computing device 40 is a mobile computing device, e.g., a smartphone or a tablet computing device. It is noted that the computing device 40, however, can be a stationary computing device, e.g., a desktop computing device.

The computing device 40 transmits a network request to a webserver 50 using the network location. The webserver 50 receives the network request and provides website data to the computing device 40. The website data can include a graphical user interface (GUI) that allows the recipient to perform requested actions. In this way, the recipient may review, add, change or submit data related to the recipient and the legal proceeding. For example, the GUI can allow a potential class member to join a class action lawsuit, to provide requested information, and/or cast a ballot in a litigation settlement administration or bankruptcy case.

In some embodiments, the webserver 50 can maintain a database that stores recipient information for a plurality of recipients. Examples of recipient information can include, but are not limited to, a name of the recipient, an address of the recipient, and information relating to the proceeding. For example, if a class action lawsuit arises from a products liability action, the recipient information can include information specific to the product, e.g., product name, product description, and purchase date. The database can be queried using unique recipient identifier.

When the computing device 40 decodes the QR code 120, the computing device 40 can include the unique recipient information in the network request. In response to the network request, the webserver 50 can access the database using the unique recipient information to obtain recipient information. The webserver 50 retrieves the recipient information and provides the recipient information to the computing device 40 with the website data. The computing device 40 can then display the website and can prepopulate any fields in the website using the recipient information. For example, fields corresponding to a name of the recipient, an address of the recipient, and a product purchased by the recipient can be prepopulated in the fields.

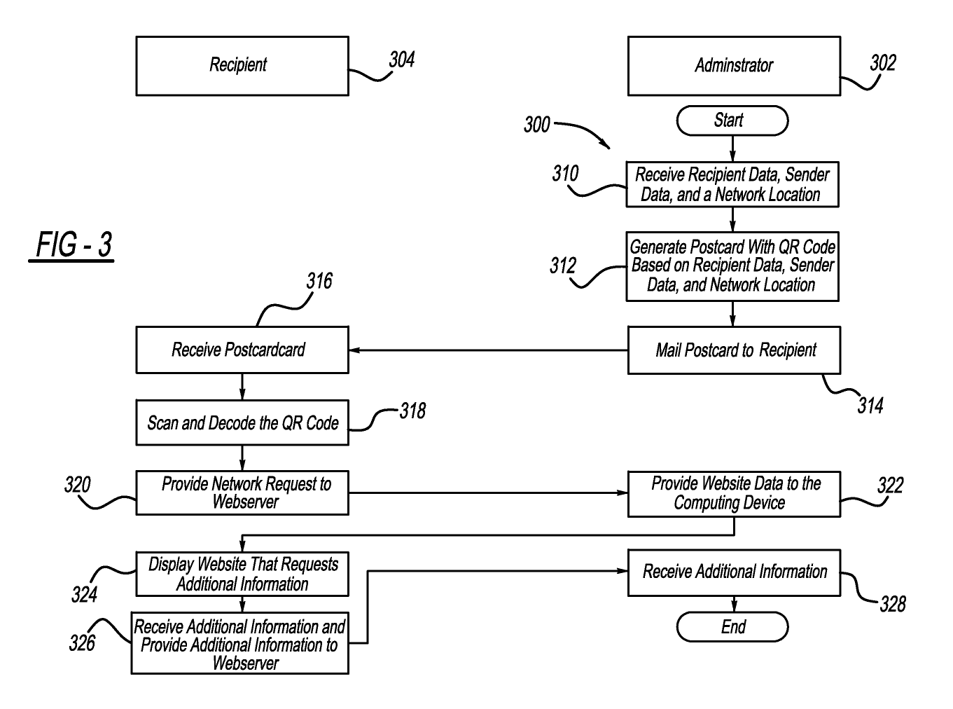

Referring now to FIG. 3, an exemplary method 300 for administering a legal proceeding using a postcard is illustrated. The method 300 is explained as being partially performed on an administrator side 302 and a recipient side 304. The administrator side 302 can include the postcard generation apparatus 20, the printer 30, and the webserver 50 (FIG. 1). It should be appreciated that while the administrator side 302 includes all of these components, the webserver 50 may be operated and maintained by a separate entity than the postcard generation apparatus 20 and webserver 50. Furthermore, while the method is explained as being performed for one recipient, the techniques disclosed herein can be modified to be performed for multiple recipients.

At step 310, the administrator can provide the recipient data, sender data, and the network location to the postcard generation apparatus 20. As previously mentioned, the recipient data can include the recipient name, address, and in some embodiments, a unique identifier. The postcard generation apparatus 20 can format the matter to be printed on the postcard, e.g., formatting the recipient name and address 130 (FIG. 2A) and the sender name and address 140 (FIG. 2A). The postcard generation apparatus 20 generates a QR code 120 based on the network location and, in some embodiments, the unique recipient identifier. The QR code 120 is printed on the postcard, along with the other fields, as shown at step 312. While the foregoing is described for one recipient, it is appreciated that a batch of postcards can be generated for a plurality of recipients.

The postcard is then mailed to the recipient, as shown at step 314. The recipient receives the postcard, as shown at step 316. At operation 318, the QR code is scanned and decoded by the computing device 40, thereby obtaining the network location and, in some embodiments, the unique recipient identifier. At operation 320, the computing device 40 transmits a network request to the webserver 50 located at the network location. In some embodiments, the network request includes the unique record identifier.

At operation 322, the webserver 50 provides website data to the computing device 40 in response to the network request. As previously discussed, if the network request includes the unique recipient identifier, the webserver 50 may retrieve recipient information corresponding to the unique recipient. The recipient information can be provided to the computing device 40 as well.

At operation 324, the computing device 40 displays the website in response to receiving the website data. Further, if the webserver 50 provided recipient information, the computing device 40 may prepopulate fields in the GUI of the website with the recipient information. The website may also include instructions to perform a requested action. For example, the website may instruct the recipient to provide additional information or take an action. The requested action may be to, for example, review, add, change or submit data related to the recipient. The additional information can be related to filing claims or casting a ballot in a litigation settlement administration or bankruptcy case. At operation 426, the recipient can provide the requested additional information to the computing device 40 and the computing device 40 can transmit the additional information to the webserver 50. At operation 328, the webserver 50 receives and stores the additional information.

The foregoing method is provided for example only. The techniques disclosed can be modified without departing from the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

It is appreciated that the forgoing method is exemplary, and not intended to be limiting. Variations of the foregoing method are contemplated and within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for administering a legal proceeding comprising:
receiving, at a postcard generation apparatus having one or more processors, recipient data associated with a recipient, the recipient data including a recipient name and a recipient address, wherein the recipient is one of a plurality of recipients associated with the legal proceeding;
receiving, at the postcard generation apparatus, sender data including a sender name and a sender address;
receiving, at the postcard generation apparatus, a network location identifying a network address of a website that the recipient is to access to perform a requested action;
generating, at the postcard generation apparatus, a QR code based on the network location;
generating, at the postcard generation apparatus, a layout for a postcard based on the QR code, the recipient data, and the sender data;
printing the postcard; and
mailing the postcard.

2. The method of claim 1 further comprising:
scanning, by a computing device associated with the recipient, the QR code;
decoding, by the computing device, the QR code to obtain the network address;
accessing, by the computing device, the website; and
receiving, by the computing device, input from the recipient, the input corresponding to the requested action.

3. The method of claim 2, wherein the requested action is to provide requested information.

4. The method of claim 1, wherein the recipient data includes a unique recipient identifier, the unique recipient identifier distinguishes the recipient from the other recipients of the plurality of recipients

5. The method of claim 4, wherein the QR code is further generated based on the unique recipient identifier, such that the unique recipient identifier is encoded into the QR code.

6. The method of claim 5, further comprising:
scanning, by a computing device associated with the recipient, the QR code;
decoding, by the computing device, the QR code to obtain the network address and the unique recipient identifier;
accessing, by the computing device, a webserver to obtain website data for displaying the website;
receiving, by the computing device, recipient information from the webserver;
displaying, by the computing device, the website;
populating, by the computing device, one or more fields in the website using the recipient information; and
receiving, by the computing device, input from the recipient, the input corresponding to the requested action;
providing, by the computing device, the input to the webserver.

7. The method of claim 5, further comprising:
receiving, by a webserver, a request for the website from a computing device associated with the recipient, the request including the unique recipient identifier;
retrieving, by the webserver, recipient information that is specific to the recipient;
providing, by the webserver, website data corresponding to the website and the recipient information, such that the website data is used to display the website at the computing device and the recipient information is used to populate fields within the website.

8. The method of claim 1, wherein the plurality of recipients are one of members in the class action lawsuit and potential participants in the class action lawsuit.

9. The method of claim 1, wherein the plurality of recipients are claimants in a bankruptcy proceeding.

10. A method for administering a legal proceeding comprising:
receiving, at a postcard generation apparatus, recipient data associated with the user and including a recipient name, a recipient address, and a unique recipient identifier, wherein the recipient is one of a plurality of recipients associated with the legal proceeding, the unique recipient identifier distinguishing the recipient from the other recipients of the plurality of recipients;
receiving, at the postcard generation apparatus, sender data including a sender name and a sender address;
receiving, at the postcard generation apparatus, a network location identifying a network address of a website that the recipient is to access and perform a requested action;
generating, at the postcard generation apparatus, a QR code based on the network location and the unique recipient identifier;
generating, at the postcard generation apparatus, a layout of postcard based on the QR code, the recipient data, and the sender data;
printing the postcard; and
mailing the postcard.

11. The method of claim 10, further comprising:
scanning, by a computing device associated with the recipient, the QR code;
decoding, by the computing device, the QR code to obtain the network address and the unique recipient identifier;
accessing, by the computing device, a webserver to obtain website data for displaying the website;
receiving, by the computing device, recipient information from the webserver;
displaying, by the computing device, the website;
populating, by the computing device, one or more fields in the website using the recipient information; and
receiving, by the computing device, input from the recipient, the input corresponding to the requested action;
providing, by the computing device, the input to the webserver.

12. The method of claim 10, further comprising:
receiving, by a webserver, a request for the website from a computing device associated with the recipient, the request including the unique recipient identifier;
retrieving, by the webserver, recipient information that is specific to the recipient;
providing, by the webserver, website data corresponding to the website and the recipient information, such that the website data is used to display the website at the computing device and the recipient information is used to populate fields within the website.

13. The method of claim 10, wherein the requested action is to provide requested information.

14. The method of claim 10, wherein the legal preceding is a class action lawsuit.

15. The method of claim 10, wherein the plurality of recipients are one of participants in the class action lawsuit and potential participants in the class action lawsuit.

16. The method of claim 1, wherein the plurality of recipients are claimants in a bankruptcy proceeding.
